(19) United States
(12) Patent Application Publication
(10) Pub. No.: US 2018/0334014 A1
(43) Pub. Date: Nov. 22, 2018

(54) AIR CONDITIONER

(71) Applicant: HONDA MOTOR CO., LTD., Tokyo (JP)

(72) Inventors: Toru Nakasako, Wako-shi (JP); Yoshiyuki Takeuchi, Wako-shi (JP)

(21) Appl. No.: 15/978,292

(22) Filed: May 14, 2018

(30) Foreign Application Priority Data
May 19, 2017 (JP) 2017-099505

(51) Int. Cl. B60H 1/32; B60L 1/04; B60H 1/00

(52) U.S. Cl. CPC B60H 1/321; B60L 1/04; B60H 2001/2287; B60H 1/00392; B60H 1/00428

(57) ABSTRACT

A control unit, at the time of a heating operation, pressure-reduces refrigerant that has passed through an indoor condenser, by an expansion valve, and thereafter introduces the refrigerant into an outdoor heat exchanger to thereby perform heat exchange with outside air. Further, the control unit, at the time of a defrosting operation, introduces high-temperature and high-pressure refrigerant compressed by a compressor into the outdoor heat exchanger to thereby remove frost adhering to the outdoor heat exchanger. Furthermore, the control unit determines whether to perform the defrosting operation or not, based on the amount of electric power required for the defrosting operation.

### CROSS-REFERENCE TO RELATED APPLICATION

This application is based upon and claims the benefit of priority from Japanese Patent Application No. 2017-099505 filed on May 19, 2017, the contents of which are incorporated herein by reference.

### BACKGROUND OF THE INVENTION

### Field of the Invention

The present invention relates to an air conditioner provided in a transport machine which acquires a driving force by driving a motor by electric power of a storage battery, the air conditioner being configured to perform a heating operation and a defrosting operation.

### Description of the Related Art

Japanese Laid-Open Patent Publication No. 2016-049914 discloses an air conditioner provided on a vehicle having an electric motor as a drive source and which performs a so-called defrosting operation for removing frost that adheres to an outdoor heat exchanger due to a heating operation. The defrosting operation is performed by introducing high-temperature and high-pressure refrigerant compressed by a compressor into the outdoor heat exchanger. This air conditioner starts the defrosting operation when the vehicle is parked, and continues the defrosting operation until the outlet temperature of the outdoor heat exchanger becomes equal to or higher than a prescribed temperature, which is a stop condition for the defrosting operation.

### SUMMARY OF THE INVENTION

In the air conditioner described in Japanese Laid-Open Patent Publication No. 2016-049914, it is difficult to appropriately set the prescribed temperature, which is the stop condition for the defrosting operation. For example, if the prescribed temperature is set to be low, electric power consumption can be suppressed because the operating time for the defrosting operation is shortened. However, frost adhering to the outdoor heat exchanger may not be removed sufficiently. In this case, the heat-absorbing performance of the outdoor heat exchanger is not recovered sufficiently. On the other hand, if the prescribed temperature is set to be high, the frost adhering to the outdoor heat exchanger can be removed reliably. However, the operating time for the defrosting operation becomes longer. In a case that the defrosting operation is performed by use of electric power of a battery (storage battery), the remaining charge amount (remaining capacity) of the battery decreases, so that the cruising distance of the vehicle after the defrosting operation becomes shorter.

In short, in the air conditioner described in Japanese Laid-Open Patent Publication No. 2016-049914, the amount of electric power consumed by the defrosting operation is not taken into consideration before the defrosting operation is performed. Therefore, the defrosting operation is continued until the outlet temperature of the outdoor heat exchanger becomes equal to or higher than the prescribed temperature. As a result, there is concern that the amount of electric power consumed in the defrosting operation may increase and then the remaining capacity of the battery may become lower than expected.

The present invention has been made with the aforementioned problems taken into consideration, and it is an object of the present invention to provide an air conditioner in which it is possible to give a longer cruising distance of a vehicle by appropriately performing a defrosting operation at the time when frost formation occurs on an outdoor heat exchanger.

According to an aspect of the present invention, there is provided an air conditioner provided in a transport machine which acquires a driving force by driving a motor by electric power of a storage battery, and the air conditioner includes an electrically operated compressor configured to compress refrigerant, an indoor condenser configured to radiate heat of the refrigerant discharged from the compressor, a pressure reducing device configured to pressure-reduce the refrigerant that has passed through the indoor condenser, an outdoor heat exchanger configured to perform heat exchange between outside air and the refrigerant having passed through the indoor condenser or the refrigerant having been pressure-reduced by the pressure reducing device, and a control unit configured to perform air-conditioning control using the refrigerant. The control unit, at the time of a heating operation, pressure-reduces the refrigerant that has passed through the indoor condenser, by the pressure reducing device, and thereafter introduces the refrigerant into the outdoor heat exchanger to thereby perform heat exchange with the outside air. The control unit, at the time of a defrosting operation, introduces high-temperature and high-pressure refrigerant compressed by the compressor into the outdoor heat exchanger to thereby remove frost adhering to the outdoor heat exchanger. The control unit is also configured to determine whether to perform the defrosting operation or not, based on an amount of electric power required for the defrosting operation.

With the above structure, since whether to perform the defrosting operation or not is determined based on the amount of electric power required for the defrosting operation, it is possible to determine whether a longer cruising distance is given by performing the defrosting operation or by not performing the defrosting operation. As a result, it is possible to give a longer cruising distance of the vehicle by appropriately performing the defrosting operation based on the state of the storage battery.

In the aspect of the present invention, the control unit may calculate a remaining capacity of the storage battery after the defrosting operation, based on the amount of electric power, and determine whether to perform the defrosting operation or not, based on the remaining capacity.

With the above structure, whether to perform the defrosting operation is determined based on the remaining capacity of the storage battery after the defrosting operation. Since if a threshold value is set, it is possible to determine whether to perform the defrosting operation or not, by determining whether the remaining capacity of the storage battery is more than the threshold value or less than the threshold value, it is possible to give a longer cruising distance of the vehicle by appropriately performing the defrosting operation depending on the state of the storage battery.

In the aspect of the present invention, the control unit may determine whether to perform the defrosting operation or not, based on an amount of electric power per unit traveling distance required for the transport machine to travel.

With the above structure, since the electric energy required for the defrosting operation can be calculated based on the electric energy per unit time required by the transport machine (electric power consumption), it is possible to estimate a possible cruising distance of the transport machine after the end of the defrosting operation.

In the aspect of the present invention, the control unit may determine whether to perform the defrosting operation or not, based on a parameter related to the frost adhering to the outdoor heat exchanger.

With the above structure, it is possible to calculate the electric energy based on the parameter related to the frost adhering to the outdoor heat exchanger, and hence it is possible to more accurately calculate the electric energy required for the defrosting operation. Furthermore, it is possible to accurately estimate a possible cruising distance after the end of the defrosting operation.

In the aspect of the present invention, the control unit may determine whether to perform the defrosting operation or not, based on the external temperature of the transport machine.

With the above structure, it is possible to accurately estimate a possible cruising distance after the end of the defrosting operation by taking the external temperature into consideration.

In the aspect of the present invention, the control unit may determine whether to perform the defrosting operation, based on outputtable electric energy of the storage battery.

The inputtable/outputtable electric energy of the storage battery differs depending on the deterioration state, temperature and the like of the storage battery. With the above structure, it is possible to accurately estimate a possible cruising distance after the end of the defrosting operation by taking the deterioration state of the storage battery into consideration.

In the aspect of the present invention, the control unit may perform the defrosting operation when an electric system of the transport machine is in an OFF state.

When the electric system is in an ON state, a request for heating might be made from the user in some cases. With the above structure, by not performing the defrosting operation when the electric system is in the ON state, it is possible to prevent the air conditioning merchantability from being degraded. Further, in some cases, the frosting state might change when the defrosting operation is performed during the heating operation. With the above structure, since the defrosting operation is performed when the electric system is in the OFF state during which the amount of frost does not increase, it is possible to accurately calculate the electric energy required for defrosting.

In the aspect of the present invention, the control unit may be configured to perform remote air-conditioning control based on a signal transmitted from the outside of the transport machine, and the control unit may perform the defrosting operation when the remote air-conditioning control is not being performed.

In some cases, heating might be requested based on remote air conditioning. The defrosting operation and the heating operation cannot be performed simultaneously. With the above structure, since, when heating is requested, the heating operation is prioritized over the defrosting operation, i.e., not performing the defrosting operation, it is possible to prevent the air conditioning merchantability from being degraded.

According to another aspect of the present invention, there is provided an air conditioner is provided in a transport machine which acquires a driving force by driving a motor by electric power of a storage battery. The air conditioner includes an electrically operated compressor configured to compress refrigerant, an indoor condenser configured to radiate heat of the refrigerant discharged from the compressor, a pressure reducing device configured to pressure-reduce the refrigerant that has passed through the indoor condenser, an outdoor heat exchanger configured to perform heat exchange between outside air and the refrigerant having passed through the indoor condenser or the refrigerant having been pressure-reduced by the pressure reducing device, and a control unit configured to perform air-conditioning control using the refrigerant. The control unit, at the time of a heating operation, pressure-reduces the refrigerant that has passed through the indoor condenser, by the pressure reducing device, and thereafter introduces the refrigerant into the outdoor heat exchanger to thereby perform heat exchange with the outside air. The control unit, at the time of a defrosting operation, introduces high-temperature and high-pressure refrigerant compressed by the compressor into the outdoor heat exchanger to thereby remove frost adhering to the outdoor heat exchanger. The control unit is also configured to estimate an amount of electric power required for the defrosting operation before performing the defrosting operation.

With the above structure, since the electric energy required for the defrosting operation is estimated before performing the defrosting operation, it is possible to determine whether the cruising distance after the defrosting operation increases or not.

According to the present invention, since whether to perform the defrosting operation or not is determined based on the electric energy required for the defrosting operation, it is possible to prevent the remaining capacity of the storage battery from decreasing excessively. Consequently, it is possible to appropriately perform the defrosting operation depending on the state of the storage battery.

The above and other objects, features and advantages of the present invention will become more apparent from the following description when taken in conjunction with the accompanying drawings, in which a preferred embodiment of the present invention is shown by way of an illustrative example.

### BRIEF DESCRIPTION OF THE DRAWINGS

FIG. 1 is a schematic diagram of an air conditioning system having an air conditioner according to an embodiment of the present invention;

FIG. 2 is a diagram for describing operation of the air conditioner in a heating operation;

FIG. 3 is a diagram for describing operation of the air conditioner in a cooling operation;

FIG. 4 is a diagram for describing operation of the air conditioner in a defrosting operation;

FIG. 5 is a flowchart of part of a sequence of processes executed by a control unit at the time of the defrosting operation; and

FIG. 6 is a flowchart of the other part of the sequence of processes executed by the control unit at the time of the defrosting operation.

### DESCRIPTION OF THE PREFERRED EMBODIMENTS

Hereinafter, an air conditioning system having an air conditioner according to the present invention will be described in detail based on a preferred embodiment with reference to the accompanying drawings.

### [1. Configuration of Air Conditioning System 10]

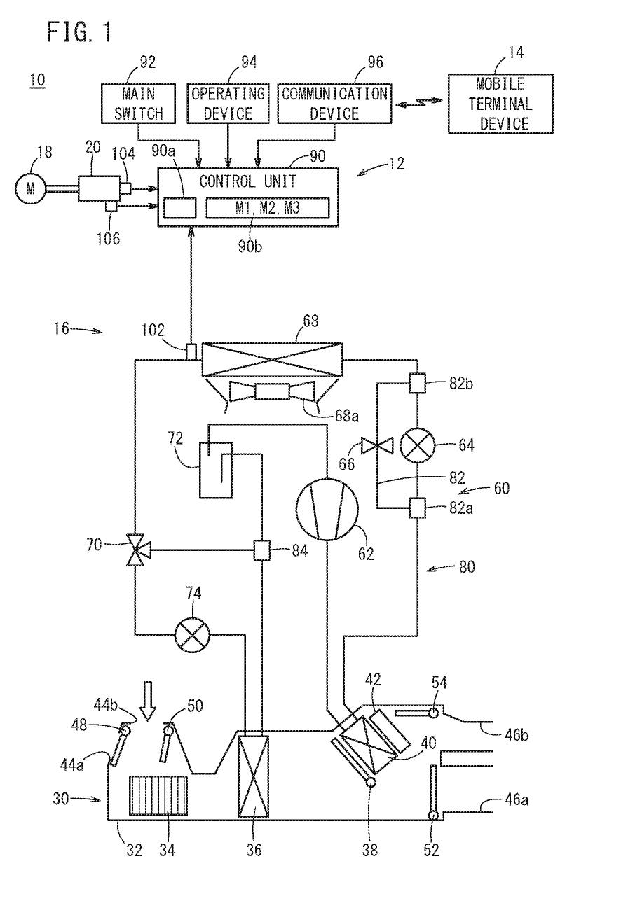

As shown in FIG. 1, an air conditioning system 10 is equipped with a transport machine 12 incorporating an air conditioner 16 and a mobile terminal device 14 carried by a user of the transport machine 12. The transport machine 12 is, for example, an electric vehicle (electric car, hybrid car or the like capable of being supplied with electricity from the outside) which drives a motor 18 by electric power of, for example, a storage battery 20 to thereby acquire a driving force. In the embodiment described below, description will be made assuming that the transport machine 12 is an electric vehicle (hereafter referred to as a vehicle 12). The mobile terminal device 14 may be a smartphone, a tablet terminal, or the like capable of data communication with the vehicle 12 through the Internet or the like, or may be a communication device capable of data communication with the vehicle 12 by use of wireless communication such as Wi-Fi (registered trademark), Bluetooth (registered trademark) or the like. The mobile terminal device 14 outputs operation signals for the air conditioner 16 in response to an input operation performed by the user.

### [2. Configuration of Vehicle 12]

The vehicle 12 is equipped with the air conditioner 16, the motor 18, and the storage battery 20. The motor 18 can also operate as a generator. The storage battery 20 supplies electric power to vehicle-mounted electrical components such as the motor 18 and the like, and is charged with electric power supplied from the motor 18 or a charging device (not shown) provided outside.

### [3. Configuration of Air Conditioner 16]

The air conditioner 16 primarily contains an air conditioning unit 30, a heat pump cycle 60 for circulating refrigerant, a control unit 90 for controlling air-conditioning by use of the refrigerant, a main switch 92 (ignition switch, power switch, or the like) configured to output a signal for switching an electric system of the vehicle 12 between ON and OFF states in response to operation performed by the user, an operating device 94 for outputting operation signals for the air conditioning depending on operation performed by the user, a communication device 96 for performing data communication with the mobile terminal device 14, and a sensor group (a refrigerant temperature sensor 102, an SOC (State-Of-Charge) sensor 104, and a charging sensor 106). An OFF state of the electric system means a state in which supply of electric power to primary electrical devices provided in the vehicle 12 is interrupted, and in addition, also means a state in which related electric devices are supplied with electric power to the extent that the control unit 90 can determine a situation in which the user does not allow the vehicle 12 to travel. Also in the present embodiment, even if an OFF signal is outputted from the main switch 92 to thereby bring the electric system into the OFF state, electric connection state is maintained between the air conditioner 16 and the storage battery 20, so that it is possible for the air conditioner 16 to perform a defrosting operation, which will be described later.

### [3-A Air Conditioning Unit 30]

The air conditioning unit 30 is equipped with a duct 32 through which air-conditioned air flows, and a blower 34, an evaporator 36, an air-mix door 38, an indoor condenser 40 and a PTC (Positive Temperature Coefficient) heater 42 which are accommodated within the duct 32.

The duct 32 has air intake ports 44a, 44b and air outlet ports 46a, 46b. Then, the aforementioned blower 34, evaporator 36, air-mix door 38 and indoor condenser 40 are arranged inside the duct 32 in this order from an upstream side (from the air intake ports 44a, 44b) toward a downstream side (toward the air outlet ports 46a, 46b) in the flow direction of air-conditioned air.

The air intake ports 44a, 44b respectively constitute an inside-air intake port for taking in inside air and an outside-air intake port for taking in outside air. The air intake ports 44a, 44b are opened and closed respectively by an inside air door 48 and an outside air door 50. For example, the opening degrees of the inside air door 48 and the outside air door 50 are regulated under control of the control unit 90, whereby the flow ratio between the inside air and the outside air that flow into the duct 32 can be adjusted.

The air outlet ports 46a, 46b respectively constitute a VENT outlet port and a DEF outlet port. The air outlet ports 46a, 46b are able to be opened and closed respectively by a VENT door 52 and a foot door 54. For example, each of the VENT door 52 and the foot door 54 is switched between opening and closing under control of the control unit 90, whereby the flow ratio between air blown out from the air outlet port 46a and air blown out from the air outlet port 46b are adjusted.

The blower 34 is operated, for example, in dependence on a drive voltage applied under the control of the control unit 90, and delivers the air-conditioned air (at least one of the inside air and the outside air) taken from the air intake ports 44a, 44b into the duct 32, toward the downstream side, that is, toward the evaporator 36 and indoor condenser 40.

The evaporator 36 performs heat exchange between low-pressure refrigerant flowing into the evaporator and the cabin atmosphere (inside the duct 32) in order to cool the air-conditioned air passing through the evaporator 36 by, for example, heat absorption occurring when the refrigerant evaporates.

The indoor condenser 40 is configured to radiate heat from high-temperature and high-pressure refrigerant flowing into the indoor condenser, and heats the air-conditioned air passing through the indoor condenser 40, for example. The PTC heater 42 is equipped with a PTC element which generates heat by supply of electric current, and operates as an auxiliary heater for the indoor condenser 40.

The air-mix door 38 is swung, for example, under the control of the control unit 90. The air-mix door 38 is swung between a heating position and a cooling position. At the heating position, a ventilation path extending from a downstream of the evaporator 36 toward the indoor condenser 40 in the duct 32 is opened. At the cooling position, a ventilation path that detours the indoor condenser 40 in the duct is opened. In this structure, with regard to the air-conditioned air having passed through the evaporator 36, the air volume ratio between air that is introduced into the indoor condenser 40 and air that detours the indoor condenser 40 and is discharged into a vehicle cabin is adjusted.

### [3-B Heat Pump Cycle 60]

The heat pump cycle 60 includes, for example, the aforementioned evaporator 36 and indoor condenser 40, a compressor 62 for compressing refrigerant, an expansion valve 64 (pressure reducing device), a solenoid valve 66, an outdoor heat exchanger 68, a three-way valve 70, a gas-liquid separator 72, and a cooling expansion valve 74. These components are connected together through a refrigerant flow passage 80.

The compressor 62 is connected between the gas-liquid separator 72 and the indoor condenser 40 in the refrigerant flow passage 80. The compressor 62 is operated by, for example, a motor (not shown) controlled by the control unit 90. The compressor 62 inhales gas-phase refrigerant (refrigerant gas) from the gas-liquid separator 72, compresses the refrigerant and discharges the high-temperature and high-pressure refrigerant to the above indoor condenser 40. The expansion valve 64 and the solenoid valve 66 are arranged in parallel along the refrigerant flow passage 80 on the downstream side of the indoor condenser 40.

The expansion valve 64 is a so-called throttle valve. The expansion valve 64 pressure-reduces and expands the refrigerant discharged from the indoor condenser 40, and thereafter discharges, to the outdoor heat exchanger 68, the refrigerant as gas-liquid two-phase (liquid-phase rich) atomized refrigerant which is lower in temperature than the outside temperature and low in pressure. Incidentally, as described in the above-mentioned Japanese Laid-Open Patent Publication No. 2016-049914, the opening diameter of the expansion valve 64 may be adjustable. In this case, during the defrosting operation, the opening diameter of the expansion valve 64 is switched to a larger opening diameter than that during the heating operation. By expanding the opening diameter of the opening of the expansion valve 64, the refrigerant passing therethrough is prevented from being pressure-reduced largely by the expansion valve 64.

The solenoid valve 66 is connected to a bypass flow passage 82 of the refrigerant flow passage 80. The bypass flow passage 82 branches from a first branch portion 82a on the upstream side of the expansion valve 64 and merges with a second branch portion 82b on the downstream side of the expansion valve 64. The solenoid valve 66 is controlled by the control unit 90 to be opened or closed. Incidentally, the solenoid valve 66 is held in a closed state during the execution of the heating operation, and is held in an opened state during the execution of the cooling operation or the defrosting operation.

With this structure, during the execution of, for example, the heating operation, the refrigerant discharged from the indoor condenser 40 is largely pressure-reduced by the expansion valve 64 to thereby be in a state of being lower in temperature than the outside temperature and being low in pressure, and flows into the outdoor heat exchanger 68. Further, during the execution of the cooling operation or defrosting operation, the refrigerant discharged from the indoor condenser 40 passes through the solenoid valve 66, and flows into the outdoor heat exchanger 68 in a high-temperature state.

The outdoor heat exchanger 68 is disposed outside the vehicle cabin, for example, behind a front grille, and performs heat exchange between refrigerant flowing into the outdoor heat exchanger and the atmosphere outside the vehicle cabin. During the heating operation, refrigerant that is lower in temperature than the outside temperature and lower in pressure flows inside the outdoor heat exchanger 68. At this time, the outdoor heat exchanger 68 absorbs heat from the atmosphere outside the vehicle cabin and raises the temperature of the refrigerant therein. During the defrosting operation, refrigerant that is higher in temperature than the outside temperature flows inside the outdoor heat exchanger 68. At this time, the outdoor heat exchanger 68 removes (defrosts) the frost adhering to the outer surface of the outdoor heat exchanger 68. During the execution of the cooling operation, refrigerant that is high in temperature flows inside the outdoor heat exchanger 68. At this time, the outdoor heat exchanger 68 radiates heat toward the atmosphere outside the vehicle cabin to thereby cool the refrigerant thereinside. A condenser fan 68a may be provided on the front side of the outdoor heat exchanger 68 to cool the refrigerant by the condenser fan 68a blowing.

Under switching operation of the three-way valve 70, the refrigerant flowing out of the outdoor heat exchanger 68 is selectively discharged to the gas-liquid separator 72 and to the cooling expansion valve 74. Specifically, the three-way valve 70 is connected to the outdoor heat exchanger 68, a merging portion 84 disposed on the gas-liquid separator 72 side, and the cooling expansion valve 74, and, for example, under control of the control unit 90, switches between the flow directions of the refrigerant. During execution of the heating operation or the defrosting operation, the three-way valve 70 discharges the refrigerant flowing out of the outdoor heat exchanger 68, to the merging portion 84 on the gas-liquid separator 72 side. Further, during execution of the cooling operation, the three-way valve 70 discharges the refrigerant flowing out of the outdoor heat exchanger 68 to the cooling expansion valve 74.

The gas-liquid separator 72 is connected between the merging portion 84 and the compressor 62 in the refrigerant flow passage 80. The gas-liquid separator 72 separates gas and liquid of the refrigerant flowing out of the merging portion 84 from each other, and causes the compressor 62 to inhale gas-phase refrigerant (refrigerant gas).

The cooling expansion valve 74 is a so-called throttle valve, and is connected between the three-way valve 70 and an inlet port of the evaporator 36 in the refrigerant flow passage 80. For example, a valve opening degree of the cooling expansion valve 74 is controlled by the control unit 90, whereby the refrigerant flowing out of the three-way valve 70 is pressure-reduced and expanded depending on the valve opening degree. Thereafter, the refrigerant is turned into an atomized state of gas-liquid two-phase (gas-phase rich) under a lower temperature and a lower pressure, and then discharged to the evaporator 36.

The evaporator 36 is connected between the cooling expansion valve 74 and the merging portion 84 (the gas-liquid separator 72) in the refrigerant flow passage 80.

### [3-C Control Unit 90]

The control unit 90 is an ECU (Electronic Control Unit) and executes various kinds of controls by a processor 90a such as a CPU or the like reading out and executing programs stored in a storage device 90b. Specifically, the control unit 90 performs controls by transmitting electric signals to respective operation portions of the air conditioning unit 30 and the heat pump cycle 60, based on operation signals outputted from the operating device 94 provided in the vehicle cabin or from the mobile terminal device 14. The control unit 90 is configured to switch operation of the air conditioner 16 among a heating operation mode, a cooling operation mode, an air blowing operation mode, a defrosting operation mode or the like. Furthermore, the control unit 90 starts the defrosting operation at the time when a predetermined condition is satisfied. Various detection signals from the refrigerant temperature sensor 102, the SOC sensor 104, and the charging sensor 106 are inputted to the control unit 90.

Incidentally, the storage device 90b stores therein various maps M1, M2, M3 prepared based on actual measurements, simulations and the like, and information on arithmetic expressions and equations, in addition to various programs and various threshold values.

### [3-D Operating Device 94]

The operating device 94 is a device which the user operates when starting or stopping operation of the air conditioner 16 and when changing the settings for air conditioning (operation mode, temperature). The operating device 94 outputs operation signals to the control unit 90 in dependence on operations performed by the user.

### [3-E Sensor Group]

The refrigerant temperature sensor 102 is provided at an exit of a refrigerant outflow path of the outdoor heat exchanger 68, and detects the temperature of the refrigerant (refrigerant exit temperature TXO) flowing out of the outdoor heat exchanger 68. The SOC sensor 104 detects the SOC (State-Of-Charge) of the storage battery 20. The charging sensor 106 is provided on a power supply path between the storage battery 20 and an external charging device, and detects whether the storage battery 20 is being charged or not.

### [4. Operation of Air Conditioner 16 in Each Operation Mode]

The control unit 90 causes the air conditioner 16 to operate in the heating operation mode, the cooling operation mode or the air-blowing operation mode, depending on an operation signal outputted from the operating device 94. Further, the control unit 90 causes the air conditioner 16 to operate in the defrosting operation mode if a predetermined condition is satisfied. Hereinafter, description will be made regarding operations of the air conditioner 16 in the heating operation mode, the cooling operation mode, and the defrosting operation mode.

### [4-A Heating Operation Mode]

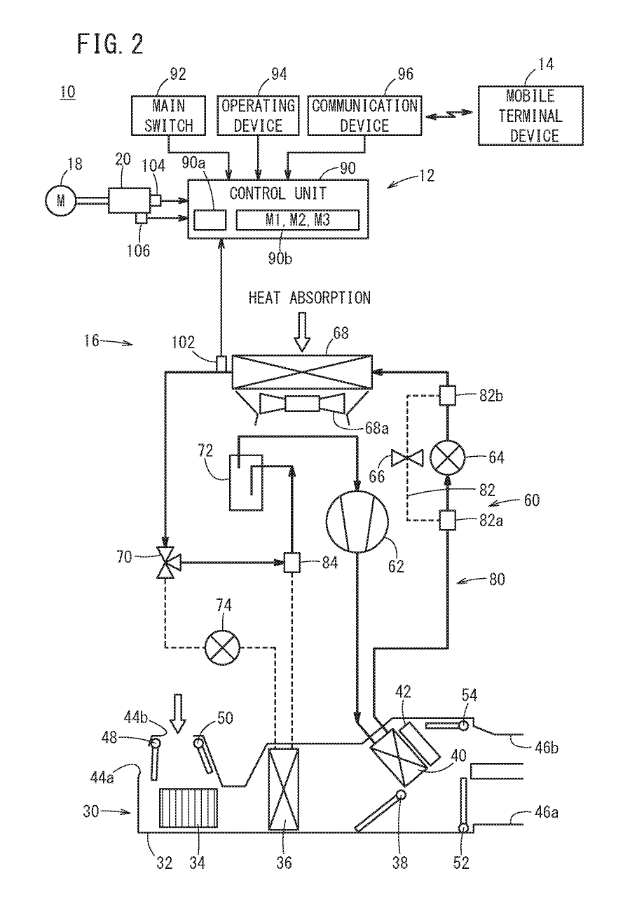

The operation of the air conditioner 16 in performing the heating operation will be described with reference to FIG. 2. Incidentally, in the refrigerant flow passage 80 and the bypass flow passage 82 shown in FIG. 2, the solid line arrows indicate the passage and direction in which the refrigerant is flowing, while the broken line arrows indicate the flow passage in which the refrigerant is not flowing.

In a case that the heating operation is performed by the air conditioner 16, the air-mix door 38 is set to the heating position at which the ventilation path toward the indoor condenser 40 is opened. The solenoid valve 66 is set to a closed state. The three-way valve 70 is set to a state of connecting the outdoor heat exchanger 68 to the merging portion 84. Incidentally, although in the air conditioning unit 30 shown in FIG. 2, the foot door 54 is in an opened state and the VENT door 52 is in a closed state, opening or closing of these doors may be changed optionally by the user's operations.

In this case, in the heat pomp cycle 60, high-temperature and high-pressure refrigerant discharged from the compressor 62 radiates heat at the indoor condenser 40 to thereby heat the air-conditioned air inside the duct 32 of the air conditioning unit 30.

In the heating operation shown in FIG. 2, the expansion valve 64 is opened, and the solenoid valve 66 is closed. Thus, the refrigerant that has radiated heat at the indoor condenser 40 passes through the expansion valve 64. The refrigerant is expanded (reduced in pressure) by the expansion valve 64 to turn into a liquid-phase-rich atomized state, and thereafter turns into a gas-phase-rich atomized state by absorbing heat from the atmosphere outside the vehicle cabin at the outdoor heat exchanger 68. The refrigerant that has passed through the outdoor heat exchanger 68 passes through the three-way valve 70 and the merging portion 84, and then flows into the gas-liquid separator 72. Then, the refrigerant having flown into the gas-liquid separator 72 is separated into gas-phase and liquid-phase, and the gas-phase refrigerant is inhaled into the compressor 62.

When the blower 34 of the air conditioning unit 30 is operated in a state that the refrigerant flows in the refrigerant flow passage 80 of the heat pump cycle 60 in the above manner, the air-conditioned air flows through the duct 32. The air-conditioned air passes through the indoor condenser 40 after passing through the evaporator 36. Then, in passing through the indoor condenser 40, the air-conditioned air is subjected to heat exchange with the refrigerant passing through the indoor condenser 40, and is supplied as heating to the vehicle cabin through the air outlet port 46b.

### [4-B Cooling Operation Mode]

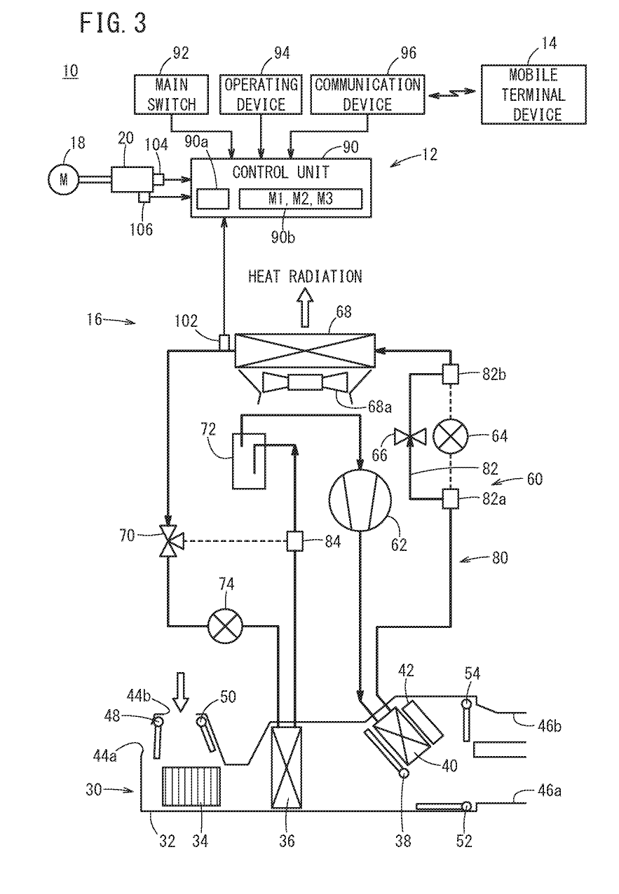

The operation of the air conditioner 16 in performing the cooling operation will be described with reference to FIG. 3. Incidentally, in the refrigerant flow passage 80 and the bypass flow passage 82 shown in FIG. 3, the solid line arrows indicate the passage and direction in which the refrigerant is flowing, while the broken line arrows indicate the flow passage in which the refrigerant is not flowing.

In a case that the cooling operation is performed by the air conditioner 16, the air-mix door 38 is set to the cooling position at which the air-conditioned air having passed through the evaporator 36 detours the indoor condenser 40. The solenoid valve 66 is set to an opened state (the expansion valve 64 in a closed state). The three-way valve 70 is set to a state of connecting the outdoor heat exchanger 68 to the cooling expansion valve 74. Incidentally, although in the air conditioning unit 30 shown in FIG. 3, the foot door 54 is in a closed state and the VENT door 52 is in an opened state, opening and closing of these doors may be changed optionally by the user's operations.

In this case, in the heat pomp cycle 60, high-temperature and high-pressure refrigerant discharged from the compressor 62 passes through the indoor condenser 40 and the solenoid valve 66, and flows into the cooling expansion valve 74 after radiating heat toward the atmosphere outside the vehicle cabin at the outdoor heat exchanger 68. At this time, the refrigerant is expanded by the cooling expansion valve 74 to turn into a liquid-phase-rich atomized state, and then cools the air-conditioned air inside the duct 32 of the air conditioning unit 30 through heat absorption at the evaporator 36.

The gas-phase-rich refrigerant having passed through the evaporator 36 passes through the merging portion 84 and then flows into the gas-liquid separator 72, and after being subjected to gas-liquid separation at the gas-liquid separator 72, the refrigerant in gas-phase is inhaled into the compressor 62.

When the blower 34 of the air conditioning unit 30 is operated in a state that the refrigerant flows as above in the refrigerant flow passage 80 of the heat pump cycle 60, the air-conditioned air flows through the duct 32, and the air-conditioned air is subjected to heat exchange with the evaporator 36 when passing through the evaporator 36. Then, after detouring the indoor condenser 40, the air-conditioned air is supplied as cooling to the inside of the vehicle cabin through the air outlet port 46a.

### [4-C Defrosting Operation Mode]

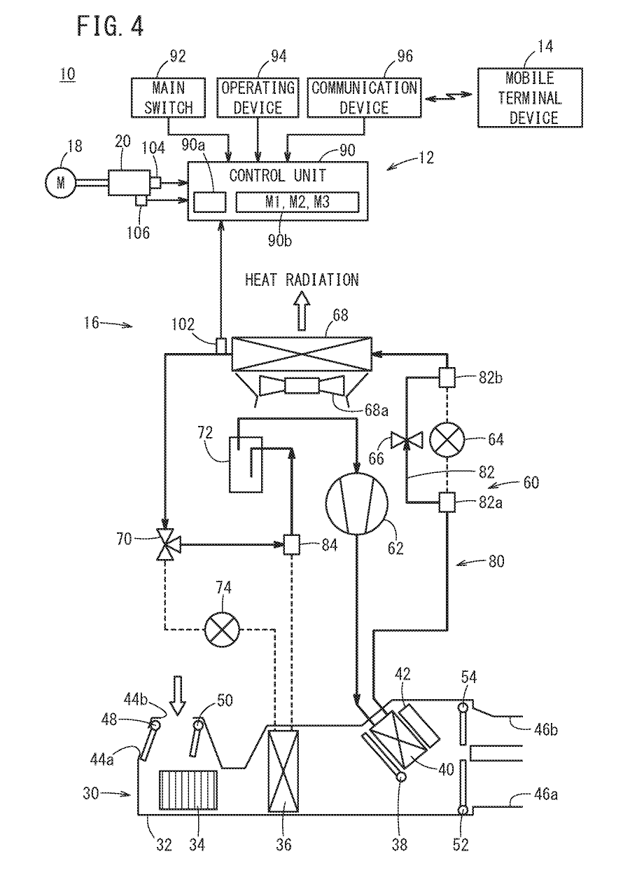

The operation of the air conditioner 16 in performing the defrosting operation will be described with reference to FIG. 4. Incidentally, in the refrigerant flow passage 80 and the bypass flow passage 82 shown in FIG. 4, the solid line arrows indicate the passage and direction in which the refrigerant is flowing, while the broken line arrows indicate the flow passage in which the refrigerant is not flowing.

In a case that the defrosting operation is performed by the air conditioner 16, the air-mix door 38 is set to a position at which the ventilation path toward the indoor condenser 40 is closed. The solenoid valve 66 is set to an opened state. The three-way valve 70 is set to a state of connecting the outdoor heat exchanger 68 to the merging portion 84. Incidentally, although in the air conditioning unit 30 shown in FIG. 4, the foot door 54 and the VENT door 52 are both in a closed state.

In the defrosting operation shown in FIG. 4, the expansion valve 64 is closed, and the solenoid valve 66 is opened. Therefore, the defrosting operation differs from the aforementioned heating operation in that the refrigerant (hot gas) compressed by the compressor 62 flows into the outdoor heat exchanger 68 as it is.

Specifically, high-temperature and high-pressure refrigerant discharged from the compressor 62 passes through the indoor condenser 40. At this time, since the air-mix door 38 closes the ventilation path toward the indoor condenser 40, the heat radiation amount of the refrigerant is small in comparison with that in the heating operation. Then, the refrigerant having passed through the indoor condenser 40 flows into the outdoor heat exchanger 68 via the solenoid valve 66. Therefore, because the refrigerant radiates heat at the outdoor heat exchanger 68, the temperature of the outdoor heat exchanger 68 is raised, whereby defrosting can be performed. Incidentally, the refrigerant having passed through the outdoor heat exchanger 68 returns to the compressor 62 by way of the same flow route as that in the aforementioned heating operation.

### [5. Processing Operation in Defrosting Operation]

### [5-A Basic Concept of Whether to Perform Defrosting Operation or Not]

Generally, when frost formation occurs on the outdoor heat exchanger 68, it becomes difficult for the refrigerant passing through the outdoor heat exchanger 68 to absorb heat from outside air, and the temperature of the refrigerant supplied to the indoor condenser 40 becomes low. Thus, the heat radiation amount from the indoor condenser 40 decreases. In this case, it is necessary to make up for the lack of the heat radiation amount of the indoor condenser 40 by using the PTC heater 42. However, since the operation of the PTC heater 42 causes electric power consumption by the PTC heater 42 to be added to the electric power consumption of the heat pump cycle 60, the entire electric power consumption by the air conditioner 16 increases. That is, when the heating operation of the air conditioner 16 is performed in a state that the frost formation occurs on the outdoor heat exchanger 68, the air conditioning electric power consumption increases. In a case that driving is performed with the air conditioning electric power consumption being in a bad state (i.e., frost formation occurs), in comparison with a case that driving is performed with the air conditioning electric power consumption being in a good state (i.e., frost formation does not occur), the electric power used for driving of the vehicle 12 (for example, the electric power used for the motor 18) becomes lower, so that the cruising distance of the vehicle 12 becomes shorter. In other words, if the defrosting of the outdoor heat exchanger 68 is performed, it is possible to increase the electric power used for driving of the vehicle 12 and hence to increase the cruising distance of the vehicle 12 (i.e., to give a longer cruising distance).

However, if the defrosting of the outdoor heat exchanger 68 is performed with the SOC of the storage battery 20 being low, the SOC of the storage battery 20 comes close to a lower limit of the usable range, and in some cases, might be lower than the lower limit. In this case, consequently, the electric power used for driving of the vehicle 12 is decreased, and hence the cruising distance of the vehicle 12 becomes short. In other words, without performing the defrosting of the outdoor heat exchanger 68, the electric power used for driving of the vehicle 12 may be larger than with performing the defrosting, and hence it is possible to give a longer cruising distance of the vehicle 12.

According to the present invention, in a case that the frost formation occurs on the outdoor heat exchanger 68, it is determined whether or not to perform the defrosting in terms of giving as long a cruising distance of the vehicle 12 as possible. Specifically, an estimation is made of the amount of electric power required for performing the defrosting, beginning with a frost formation state (hereinafter referred to as defrosting electric energy), and from the electric energy, an estimation is made of a lower-limit SOC (hereinafter referred to as a defrosting lower limit SOC) required for the storage battery 20. Then, if the SOC detected at that time exceeds the defrosting lower limit SOC, the defrosting operation is performed, and if the SOC detected at that time is lower than or equal to the defrosting lower limit SOC, the defrosting operation is not performed, whereby a longer cruising distance is given. Hereinafter, a specific processing flow will be described.

### [5-B Process Flow of Defrosting Operation]

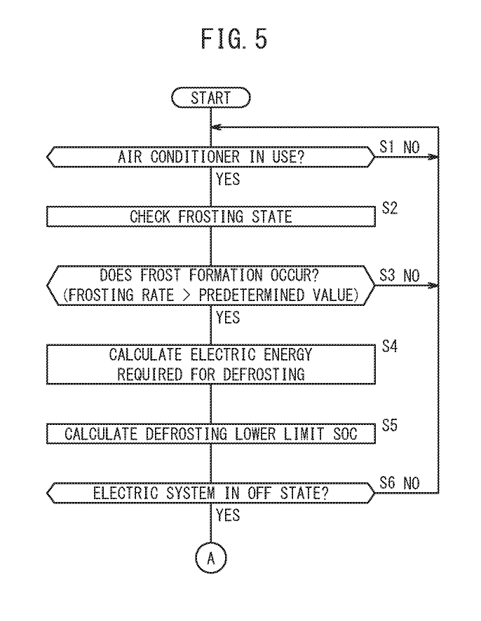

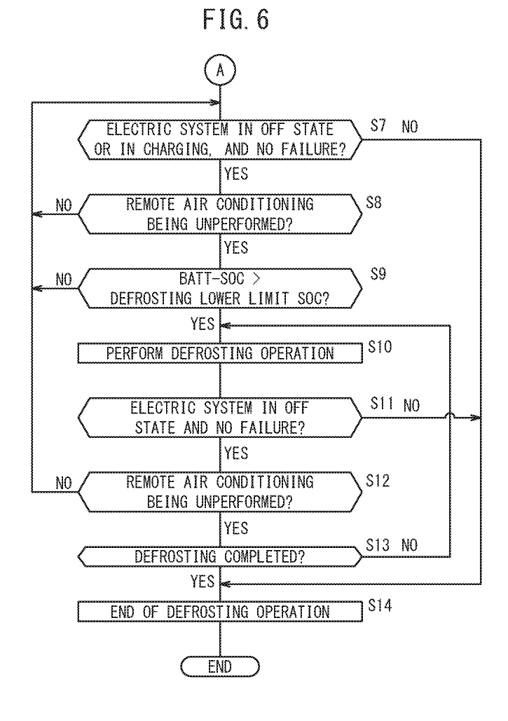

With reference to FIG. 5 and FIG. 6, description will be made regarding an example of the process flow which the control unit 90 executes in switching the operation mode of the air conditioner 16 to the defrosting operation mode. The following situation will be assumed in the example described below. For example, the user drives the vehicle 12 to a destination such as, for example, a supermarket. At this time, the air conditioner 16 is operating in the heating operation mode, and frost formation occurs on the outdoor heat exchanger 68. The supermarket is equipped with a charging station, and the user parks the vehicle 12 at the charging station to charge the storage battery 20. The user, after shopping at the supermarket, again gets into the vehicle 12 and drives to the next destination. While the vehicle 12 is parked at the charging station, the control unit 90 performs the defrosting operation as necessary.

The process flow described hereinafter is started when the electric system is turned into an ON state. In the above-mentioned situation, the following process flow is started when the user gets into the vehicle 12 and operates the main switch 92 so that an ON signal is outputted from the main switch 92. The processes of step S1 through step S6 are performed when the electric system of the vehicle 12 is in the ON state. In the above-described situation, the processes of step S1 through step S6 are performed when the vehicle 12 is traveling toward the supermarket. The processes of step S7 through step S14 are performed when the electric system of the vehicle 12 is in the OFF state. In the above-described situation, the processes of step S7 through step S14 are performed while the vehicle 12 is parked at the charging station. In the present embodiment, the defrosting operation is performed (step S10) on the condition that remote air conditioning is not being performed in a case that the SOC of the storage battery 20 exceeds the defrosting lower limit SOC (also including a case in which the SOC exceeds the defrosting lower limit SOC as a result of charging) at the time of parking of the vehicle 12 (i.e., at the time when the electric system in the OFF state). Incidentally, the subject that performs the processes described hereinafter is the control unit 90.

At step S1, it is determined whether the air conditioner 16 is currently in use or not. If the air conditioner 16 is in use (step S1: YES), the processing proceeds to step S2. On the other hand, if the air conditioner 16 is not in use (step S1: NO), the process at step S1 is repeatedly performed.

When the processing proceeds from step S1 to step S2, the frosted state of the outdoor heat exchanger 68 is checked. In the present embodiment, a frosting rate is used as a parameter indicating the frosted state. The frosting rate is estimated from a difference ΔTXO between a temperature TXO, which is the temperature of the refrigerant actually flowing out of the outdoor heat exchanger 68 at that time, and a temperature TXO_base, which is the temperature of the refrigerant flowing out of the outdoor heat exchanger 68 at a time when the frosting rate is zero percent (0%). The storage device 90b stores a map M1 indicating a correspondence relationship between the difference ΔTXO and the frosting rate, and the processor 90a of the control unit 90 reads out a frosting rate corresponding to the ΔTXO from the storage device 90b. The map M1 is set based on the result of an experiment or simulation carried out in advance. The temperature TXO of the refrigerant is acquired based on a detection value of the refrigerant temperature sensor 102. The temperature TXO_base of the refrigerant is estimated based on a calculation which is made using, as parameters, predetermined measurement values related to temperature change factors. For example, the measurement values related to temperature change factors include the outside temperature (external temperature), the vehicle speed of the vehicle 12, the rotational speed of the compressor 62, the voltage applied to the blower 34, and the like. The measurement values related to temperature change factors are acquired based on command values or detection values from sensors (not shown). Then, the processing proceeds to step S3.

At step S3, the presence or absence of the frosting (i.e., frost formation) is determined. There is a possibility that the frost formation occurs on the outdoor heat exchanger 68 when the air conditioner 16 is being operated in the heating operation mode. In the present embodiment, the presence or absence of frost formation is determined based on whether or not the frosting rate estimated at step S2 exceeds a predetermined value stored in the storage device 90b. If the frosting rate exceeds the predetermined value (step S3: YES), the processing proceeds to step S4. On the other hand, if the frosting rate is the predetermined value or less (step S3: NO), the processing returns to step S1.

At step S4, the amount of electric power required for defrosting the outdoor heat exchanger 68 is calculated. The frosting rate and the defrosting electric energy correlate with each other. The storage device 90b stores a map M2 indicating a correspondence relationship between the frosting rate and the defrosting electric energy, and the processor 90a of the control unit 90 reads out a defrosting electric energy corresponding to the frosting rate from the storage device 90b. The map M2 is set based on the result of an experiment or simulation carried out in advance. Then, the processing proceeds to step S5.

At step S5, the defrosting lower limit SOC is calculated. In the present embodiment, the control unit 90 determines (at step S9 to be described later) whether to start the defrosting operation or not, based on the SOC of the storage battery 20 (hereinafter referred to also as BATT-SOC). The defrosting lower limit SOC is calculated based on a map M3 using as a parameter the defrosting electric energy acquired at step S4.

The map M3 is set based on the result of an experiment or simulation carried out in advance. This experiment or simulation uses as parameters the defrosting electric energy, the elapsed time until reaching each frosting rate, air conditioning electric power consumption, traveling electric power consumption, a state index of the storage battery 20, etc., and is performed to finally obtain the defrosting lower limit SOC corresponding to the defrosting electric energy. The air conditioning electric power consumption means the electric power consumption of the air conditioner 16, and is calculated as the amount of electric power per unit traveling distance required for the air conditioning, that is, as the amount of air-conditioning electric power to the traveling distance. The traveling electric power consumption is the electric power consumption excluding the air conditioning electric power consumption, and is calculated as the amount of electric power excluding the air conditioning electric power per unit traveling distance, that is, is calculated by an expression of “(total electric power consumption of the storage battery 20—air conditioning electric power consumption)/traveling distance”. The state index of the storage battery 20 means, for example, the degree of deterioration (i.e., BOL: Beginning-Of-Life, EOL: End-Of-Life) and the temperature of the storage battery 20. As the storage battery 20 deteriorates with age, the internal resistance of the storage battery 20 increases so that the outputtable electric energy is lowered. The state index of the storage battery 20 can be represented by the outputtable electric energy (the internal resistance). Lower limit values in the respective ranges of the SOC within which the cruising distance increases when the defrosting is performed, are estimated by changing these parameters appropriately, and are set as the map M3. In the map M3, the defrosting electric energy is an input value, while the defrosting lower limit SOC is an output value.

At step S6, it is determined whether or not the electric system for the vehicle 12 has been placed in an OFF state. For example, the user, when getting off the vehicle 12, operates the main switch 92 to turn the electric system OFF. If the control unit 90 detects an OFF signal outputted from the main switch 92 (step S6: YES), the processing proceeds to step S7. Incidentally, if the processing proceeds to step S7, the electric system that is necessary for operating the air conditioner 16 is kept in the ON state. On the other hand, if the control unit 90 does not detect the OFF signal outputted from the main switch 92 (step S6: NO), the processing returns to step S1.

When the processing proceeds from step S6 to step S7, it is determined whether the air conditioning system is in a state for starting the defrosting operation or not, based on information on the ON/OFF state of the electric system, information on the state-of-charge of the storage battery 20 and information on the presence or absence of a failure in the air conditioner 16. The control unit 90 determines whether the storage battery 20 is in charging operation or not, based on a detection signal outputted from the charging sensor 106. Further, the control unit 90 monitors drive current values at respective operation portions of the air conditioner 16 during steps S1 through step S6. If an operation portion is subjected to an abnormal current value, it is determined and stored that an abnormality has occurred in the operation portion. If the electric system is in an OFF state (a state that an ON signal is not outputted from the main switch 92) or the storage battery 20 is in charging operation, and if no failure occurs in any of the operation portions of the air conditioner 16 (step S7: YES), the processing proceeds to step S8. On the other hand, if the electric system is not in the OFF state and the storage battery 20 is not in charging operation, or if a failure occurs at any of the operation portions of the air conditioner 16 (step S7: NO), the processing proceeds to step S14.

If the processing proceeds from step S7 to step S8, it is determined whether or not the remote air conditioning is unperformed. When the electric system of the vehicle 12 is in the OFF state, the user can operate the air conditioner 16 from the outside of the vehicle 12 by using the mobile terminal device 14 in order to perform air conditioning in the vehicle cabin. This is called “remote air conditioning”. When the remote air conditioning is performed, the air conditioner 16 is operated with the main portion of the electric system remaining in the OFF state. If the remote air conditioning is unperformed (step S8: YES), the processing proceeds to step S9. On the other hand, if the remote air conditioning is not unperformed (i.e., the remote air conditioning is being performed) (step S8: NO), the processing returns to step S7.

When the processing proceeds from step S8 to step S9, the BATT-SOC is compared with the defrosting lower limit SOC determined at step S5. The control unit 90 determines the BATT-SOC based on the detection signal outputted from the SOC sensor 104. When the electric power consumption is low before the electric system is turned OFF or when the storage battery 20 is sufficiently charged after the electric system is turned OFF, the BATT-SOC is large. If the BATT-SOC is larger than the defrosting lower limit SOC (step S9: YES), the processing proceeds to step S10. On the other hand, if the BATT-SOC is less than or equal to the defrosting lower limit SOC (step S9: NO), the processing returns to step S7.

When the processing proceeds from step S9 to step S10, the defrosting operation is performed. The control unit 90 sets the operation mode to the defrosting operation mode, and operates the operation portions of the air conditioning unit 30 and the heat pump cycle 60. Then, the processing proceeds to step S11.

At step S11, it is determined whether or not the air conditioning system is in a state for continuing the defrosting operation, based on information on the ON/OFF state of the electric system and information on the presence/absence of a failure in the air conditioner 16. If the electric system is in the OFF state and no failure occurs in any of the operation portions of the air conditioner 16 (step S11: YES), the processing proceeds to step S12. On the other hand, if the electric system is not in the OFF state or a failure occurs in any of the operation portions of the air conditioner 16 (step S11: NO), the processing proceeds to step S14.

When the processing proceeds from step S11 to step S12, it is determined whether the remote air conditioning is not being performed or not, similarly to step S8. If the remote air conditioning is not being performed (step S12: YES), the processing proceeds to step S13. On the other hand, if the remote air conditioning is being performed (step S12: NO), the processing returns to step S7.

When the processing proceeds from step S12 to step S13, it is determined whether the defrosting has been completed or not. In this case, at least one of the frosting rate, the electric energy (the amount of electric power) consumed for the defrosting, and the time consumed for the defrosting may be used as the criterion for the determination, or a plurality of the above items may be used in an OR condition as the criterion for the determination. For example, in a case that the frosting rate is used as the criterion for the determination, the control unit 90 determines the completion of the defrosting if the frosting rate becomes a predetermined value or less. The frosting rate can be estimated in the same manner as in step S2. The predetermined value used in this case may be the same as the predetermined value used at step S3 or may differ therefrom. For example, in a case that the electric energy consumed for the defrosting is used as the criterion for the determination, the control unit 90 determines the completion of the defrosting if the electric energy consumed from the beginning of the defrosting exceeds the defrosting electric energy calculated at step S4. The electric energy consumed for the defrosting is detectable by the SOC sensor 104. For example, in a case that the time consumed for the defrosting is used as the criterion for the determination, the control unit 90 determines the completion of the defrosting if the elapsed time from the beginning of the defrosting exceeds a predetermined period of time. The time consumed for the defrosting can be measured by a timer (not shown) provided in the control unit 90. If the defrosting is determined to have been completed (step S13: YES), the processing proceeds to step S14. On the other hand, if the defrosting is determined not to have been completed (step S13: NO), the processing returns to step S10, and then the defrosting operation is continued.

If the processing proceeds from any of step S7, step S11 and step S13 to step S14, the defrosting operation is terminated. The control unit 90 stops operation of the operation portions of the air conditioning unit 30 and the heat pump cycle 60.

### [6. Summary of the Present Embodiment]

The air conditioner 16 according to the present embodiment is provided in the transport machine 12 (vehicle 12) which acquires the driving force by driving the motor 18 by electric power of the storage battery 20. The air conditioner is equipped with the electrically operated compressor 62 configured to compress the refrigerant, the indoor condenser 40 configured to radiate heat of the refrigerant discharged from the compressor 62, the expansion valve 64 (pressure reducing device) configured to pressure-reduce the refrigerant that has passed through the indoor condenser 40, the outdoor heat exchanger 68 configured to perform heat exchange between outside air and the refrigerant having passed through the indoor condenser 40 or the refrigerant having been pressure-reduced by the expansion valve 64, and the control unit 90 (control unit) configured to perform the air-conditioning control using the refrigerant. At the time of the heating operation, the control unit 90 pressure-reduces the refrigerant that has passed through the indoor condenser 40, by the expansion valve 64, and thereafter introduces the refrigerant into the outdoor heat exchanger 68 to thereby perform heat exchange with the outside air. Further, at the time of the defrosting operation, the control unit 90 introduces the high-temperature and high-pressure refrigerant compressed by the compressor 62 into the outdoor heat exchanger 68 to thereby remove the frost adhering to the outdoor heat exchanger 68. Furthermore, based on the defrosting electric energy (the amount of electric power required for the defrosting operation), the control unit 90 determines whether to perform the defrosting operation or not (step S9 in FIG. 6).

With the above structure, since whether to perform the defrosting operation or not is determined based on the defrosting electric energy (the amount of electric power required for the defrosting operation), it is possible to determine whether a longer cruising distance is given by performing the defrosting operation or by not performing the defrosting operation. As a result, it is possible to increase the cruising distance of the vehicle 12 by appropriately performing the defrosting operation depending on the state of the storage battery 20.

Further, the control unit 90 calculates, based on the defrosting electric energy, the remaining capacity (the defrosting lower limit SOC) of the storage battery 20 after the defrosting operation, and determines whether to perform the defrosting operation or not, based on the remaining capacity (step S10 in FIG. 6).

With the above structure, whether to perform the defrosting operation is determined based on the remaining capacity of the storage battery 20 after the defrosting operation. If a threshold value is set, it is possible to determine whether to perform the defrosting operation or not, by determining whether the remaining capacity of the storage battery 20 is more than the threshold value or less than the threshold value. Therefore, it is possible to increase the cruising distance of the vehicle 12 by appropriately performing the defrosting operation depending on the state of the storage battery 20.

Further, the control unit 90 determines whether to perform the defrosting operation or not, based on the electric power consumption, which is the electric energy per unit traveling distance required for the transport machine 12 to travel.

With the above structure, since the defrosting electric energy can be calculated based on the electric energy per unit time required by the transport machine 12 (electric power consumption), it is possible to estimate a possible cruising distance of the transport machine 12 after completion of the defrosting operation.

Further, the control unit 90 determines whether to perform the defrosting operation or not, based on the frosting rate, which is a parameter related to the frost adhering to the outdoor heat exchanger 68.

With the above structure, it is possible to calculate the defrosting electric energy based on the frosting rate, which is a parameter related to the frost adhering to the outdoor heat exchanger 68, and hence it is possible to calculate the defrosting electric energy more accurately. Further, it is possible to accurately estimate a possible cruising distance after the end of the defrosting operation.

Further, the control unit 90 is configured to determine whether to perform the defrosting operation or not, based on the external temperature of the transport machine 12.

With the above structure, it is possible to accurately estimate a possible cruising distance after the end of the defrosting operation by taking the external temperature into consideration.

Further, the control unit 90 is configured to determine whether to perform the defrosting operation or not, based on the outputtable electric energy of the storage battery 20.

The inputtable/outputtable electric energy of the storage battery 20 differs depending on the deterioration state, temperature and the like of the storage battery 20. With the above structure, it is possible to accurately estimate a possible cruising distance after the end of the defrosting operation by taking the deterioration state of the storage battery 20 into consideration.

Further, the control unit 90 performs the defrosting operation when the electric system of the transport machine 12 is in the OFF state (step S6: YES in FIG. 5, step S7: YES in FIG. 6, step S11: YES in FIG. 6).

When the electric system is in an ON state, the user may require heating in some cases. With the above structure, by not performing the defrosting operation when the electric system is in the ON state, it is possible to prevent the air conditioning merchantability from being degraded. Further, when the defrosting operation is performed during the heating operation, the frosting state may change in some cases. With the above structure, since the defrosting operation is performed when the electric system is in the OFF state during which the amount of frost does not increase, it is possible to calculate the defrosting electric energy accurately.

Further, the control unit 90 is configured to perform the remote air-conditioning control based on a signal transmitted from outside of the transport machine 12, and the defrosting operation is performed when the remote air-conditioning control is not being performed (step S8: YES, step S12: YES).

In some cases, heating may be requested based on the remote air conditioning. The defrosting operation and the heating operation cannot be performed simultaneously. With the above structure, when heating is requested, the heating operation is prioritized over the defrosting operation, i.e., not performing the defrosting operation, and hence it is possible to prevent the air conditioning merchantability from being degraded.

In another aspect of the present embodiment, the air conditioner 16 is provided in the transport machine 12 which acquires the driving force by driving the motor 18 by the electric power of the storage battery 20. The air conditioner 16 includes the electrically operated compressor 62 configured to compress the refrigerant, the indoor condenser 40 configured to radiate heat of the refrigerant discharged from the compressor 62, the expansion valve 64 (pressure reducing device) configured to pressure-reduce the refrigerant that has passed through the indoor condenser 40, the outdoor heat exchanger 68 configured to perform heat exchange between the outside air and the refrigerant having passed through the indoor condenser 40 or the refrigerant having been pressure-reduced by the expansion valve 64, and the control unit 90 (control unit) configured to perform the air-conditioning control using the refrigerant. At the time of the heating operation, the control unit 90 pressure-reduces the refrigerant that has passed through the indoor condenser 40, by the expansion valve 64, and thereafter introduces the refrigerant into the outdoor heat exchanger 68 to thereby perform heat exchange with the outside air. Further, at the time of the defrosting operation, the control unit 90 introduces the high-temperature and high-pressure refrigerant compressed by the compressor 62 into the outdoor heat exchanger 68 to thereby remove the frost adhering to the outdoor heat exchanger 68. Furthermore, before performing the defrosting operation, the control unit 90 estimates the defrosting electric energy (the amount of electric power needed for the defrosting operation) (step S4 in FIG. 5).

With the above structure, since the defrosting electric energy is estimated before performing the defrosting operation, it is possible to determine whether the cruising distance after the defrosting operation increases or not.

With the above structure, when the SOC of the storage battery 20 exceeds the defrosting lower limit SOC, the cruising distance of the vehicle 12 is increased as a result of performing the defrosting operation, in comparison with a case of not performing the defrosting operation. Further, when the SOC of the storage battery 20 is less than or equal to the defrosting lower limit SOC, the cruising distance of the vehicle 12 as a result of not performing the defrosting operation is longer than the cruising distance as a result of performing the defrosting operation.

Incidentally, the air conditioner according to the present invention is not limited to the foregoing embodiment, and it is a matter of course that various configurations could be adopted therein without deviating from the scope of the present invention.

For example, the defrosting lower limit SOC may be estimated by using, as parameters, a destination or the like of the vehicle stored in a navigation system or the like, that is, a distance by which the vehicle 12 will travel from the current position.

What is claimed is:

1. An air conditioner provided in a transport machine which acquires a driving force by driving a motor by electric power of a storage battery, the air conditioner comprising:
an electrically operated compressor configured to compress refrigerant;
an indoor condenser configured to radiate heat of the refrigerant discharged from the compressor;
a pressure reducing device configured to pressure-reduce the refrigerant that has passed through the indoor condenser;
an outdoor heat exchanger configured to perform heat exchange between outside air and the refrigerant having passed through the indoor condenser or the refrigerant having been pressure-reduced by the pressure reducing device; and
a control unit configured to perform air-conditioning control using the refrigerant;
wherein the control unit is configured to:
at a time of a heating operation, pressure-reduce the refrigerant that has passed through the indoor condenser, by the pressure reducing device, and thereafter introduce the refrigerant into the outdoor heat exchanger to thereby perform heat exchange with the outside air; and
at a time of a defrosting operation, introduce high-temperature and high-pressure refrigerant compressed by the compressor into the outdoor heat exchanger to thereby remove frost adhering to the outdoor heat exchanger; and
wherein the control unit is also configured to determine whether to perform the defrosting operation or not, based on an amount of electric power required for the defrosting operation.

2. The air conditioner according to claim 1, wherein:
the control unit calculates a remaining capacity of the storage battery after the defrosting operation, based on the amount of electric power, and determines whether to perform the defrosting operation or not, based on the remaining capacity.

3. The air conditioner according to claim 1, wherein:
the control unit determines whether to perform the defrosting operation or not, based on an amount of electric power per unit traveling distance required for the transport machine to travel.

4. The air conditioner according to claim 1, wherein:
the control unit determines whether to perform the defrosting operation or not, based on a parameter related to the frost adhering to the outdoor heat exchanger.

5. The air conditioner according to claim 1, wherein:
the control unit determines whether to perform the defrosting operation or not, based on an external temperature of the transport machine.

6. The air conditioner according to claim 1, wherein:
the control unit determines whether to perform the defrosting operation or not, based on an outputtable amount of electric power of the storage battery.

7. The air conditioner according to claim 1, wherein:
the control unit performs the defrosting operation when an electric system of the transport machine is in an OFF state.

8. The air conditioner according to claim 1, wherein:
the control unit is configured to perform remote air-conditioning control based on a signal transmitted from outside of the transport machine; and
the control unit performs the defrosting operation when the remote air-conditioning control is not being performed.

9. An air conditioner provided in a transport machine which acquires a driving force by driving a motor by electric power of a storage battery, the air conditioner comprising:
an electrically operated compressor configured to compress refrigerant;
an indoor condenser configured to radiate heat of the refrigerant discharged from the compressor;
a pressure reducing device configured to pressure-reduce the refrigerant that has passed through the indoor condenser;
an outdoor heat exchanger configured to perform heat exchange between outside air and the refrigerant having passed through the indoor condenser or the refrigerant having been pressure-reduced by the pressure reducing device; and
a control unit configured to perform air-conditioning control using the refrigerant;
wherein the control unit is configured to:
at a time of a heating operation, pressure-reduce the refrigerant that has passed through the indoor condenser, by the pressure reducing device, and thereafter introduce the refrigerant into the outdoor heat exchanger to thereby perform heat exchange with the outside air; and
at a time of a defrosting operation, introduce high-temperature and high-pressure refrigerant compressed by the compressor into the outdoor heat exchanger to thereby remove frost adhering to the outdoor heat exchanger; and
wherein the control unit is also configured to estimate an amount of electric power required for the defrosting operation before performing the defrosting operation.
